(19) United States
(12) Patent Application Publication
(10) Pub. No.: US 2025/0219433 A1
(43) Pub. Date: Jul. 3, 2025

(54) SWITCHING POWER SUPPLY, POWER REPLENISHMENT CIRCUIT AND POWER REPLENISHMENT METHOD

(71) Applicant: LII SEMICONDUCTOR CO., LTD, Shenzhen (CN)

(72) Inventors: Fulong WANG, Shenzhen (CN); Jie ZHANG, Shenzhen (CN); Lingbo ZHENG, Shenzhen (CN); Min ZHU, Shenzhen (CN)

(73) Assignee: LII SEMICONDUCTOR CO., LTD, Shenzhen (CN)

(21) Appl. No.: 19/081,214

(22) Filed: Mar. 17, 2025

Related U.S. Application Data
(63) Continuation of application No. PCT/CN2023/097167, filed on May 30, 2023.

(30) Foreign Application Priority Data
Oct. 27, 2022 (CN) 202211329925.1

(51) Int. Cl. H02J 7/00; H02M 3/335

(52) U.S. Cl. CPC H02J 7/00712; H02M 3/33515; H02J 2207/20; H02J 2207/50

(57) ABSTRACT

Disclosed are a switching power supply, a power replenishment circuit and a power replenishment method. The switching power supply replenishment circuit includes a control module configured to output a control signal for adjusting an output voltage of the switching power supply; a charging capacitor configured to store electric energy and power the control module; a withstand voltage switch tube configured to obtain a power supply voltage of the primary winding and output a charging voltage for charging the charging capacitor; a charging switch tube configured to control whether the charging capacitor is charged; a primary control loop configured to control whether the primary winding is turned on; a charging control unit configured to control whether the charging switch tube is turned on; the charging control unit including: a voltage sampling feedback device configured to detect a voltage signal of the auxiliary winding.

### CROSS-REFERENCE TO RELATED APPLICATIONS

This application is a continuation application of International Application No. PCT/CN2023/097167, filed on May 30, 2023, which claims priority to Chinese Patent Application No. 202211329925.1, filed on Oct. 27, 2022. The disclosures of the aforementioned applications are incorporated herein by reference in their entireties.

### TECHNICAL FIELD

The present application relates to the technical field of switching power supply control, in particular to a switching power supply, a power replenishment circuit and a power replenishment method.

### BACKGROUND

With the diversification of electronic devices, power supply technology has experienced unprecedented development, switching speeds have become faster, power levels have increased, and chip sizes have become smaller, which imposes higher requirements on the development indicators of switching power supply control technology.

The working voltage of the existing flyback switching power supply control chip is provided by the auxiliary coil winding of the transformer, which is configured to ensure the normal operation of each module of the switching power supply chip. The switching power supply has a self-powered circuit, which will cause the switching power supply to generate charging energy loss. In addition, as gallium nitride transistors are more and more widely used in the field of switching power supplies, new power supply methods are also generated. Therefore, it is very necessary to provide a switching power supply gallium nitride valley self-powered circuit and method to reduce the charging loss of the switching power supply.

### SUMMARY

In order to reduce the charging loss of a switching power supply, the present application provides a switching power supply, a power replenishment circuit and a power replenishment method.

In a first aspect, the present application provides a switching power supply power replenishment circuit, which adopts the following technical solution.

The switching power supply power replenishment circuit, applied to a non-continuous mode flyback switching power supply, includes:
a control module configured to output a control signal for adjusting an output voltage of the switching power supply;
a charging capacitor configured to store electric energy and provide electric energy for the switching power supply;
a withstand voltage switch tube connected between a primary winding and the charging capacitor and configured to obtain a charging voltage for charging the charging capacitor;
a charging switch tube connected between the charging capacitor and the withstand voltage switch tube and configured to control whether the charging capacitor is charged;
a primary control loop configured to control whether the primary winding is turned on, when the primary winding is turned on, the primary winding stores energy; and
a charging control unit configured to control whether the charging switch tube is turned on;
the charging control unit includes:
a voltage sampling feedback device configured to detect a voltage signal of an auxiliary winding, and output a sampling signal to the control module when the voltage signal is at a resonance bottom according to the voltage signal;
the control module is configured to receive the sampling signal and output a resonance bottom signal; and
an output end of the control module is coupled to a control electrode of the charging switch tube to enable the charging switch tube to be turned on when it receives the resonance bottom signal.

By adopting the above technical solution, the resonant valley voltage is detected by the charging control unit, and a resonant valley signal is output to the control module to control the charging switch tube to be turned on. The switching power supply is charged at the resonance valley, so that the source of the withstand voltage switch tube is in a low voltage state, that is, the charging loss of the switching power supply is reduced when the charging circuit is turned on.

In an embodiment, the charging control unit further includes a voltage sampler and a first AND logic device;
the voltage sampler is preset with a high voltage reference value and a low voltage reference value, and the voltage sampler is configured to obtain a voltage signal of the charging capacitor, and compare the voltage signal with the low voltage reference value or the high voltage reference value to output a judgment signal; and
an input end of the first AND logic device is respectively connected to the voltage sampler and the control module, and is configured to obtain a judgment signal and a resonance valley bottom signal, an output end of the first AND logic device is connected to the charging switch tube, and is configured to control the charging switch tube to be turned on or off.

By adopting the above technical solution, the low voltage reference value preset by the voltage sampler can ensure that when the switching power supply is fully charged, the switching power supply will no longer be charged. The high voltage reference value preset by the voltage sampler can ensure that the switching power supply can store sufficient electrical energy to meet the energy consumption of the control module.

In an embodiment, the voltage sampler includes a voltage comparator, a low voltage reference circuit and a high voltage reference circuit; the low voltage reference circuit or the high voltage reference circuit is connected to an input end of the voltage comparator, the low voltage reference circuit is configured to provide a low voltage reference value, the high voltage reference circuit is configured to provide a high voltage reference value; the other input end of the voltage sampler is connected to the charging capacitor to obtain the voltage signal of the charging capacitor, the voltage sampler compares the voltage signal with the low voltage reference value or the high voltage reference value and outputs the judgment signal; and an output end of the voltage sampler is connected to the charging switch tube to control whether the charging switch tube is turned on.

By adopting the above technical solution, the setting of the low voltage reference circuit and the high voltage reference circuit can realize the jump of the low voltage reference value and the high voltage reference value.

In an embodiment, a first conductive member is provided between an output end of the voltage comparator and the low voltage reference circuit, a second conductive member is provided between the output end of the voltage comparator and the high voltage reference circuit; and the first conductive member is configured to control whether the low voltage reference circuit is connected to the voltage comparator, the second conductive member is configured to control whether the high voltage reference circuit is connected to the voltage comparator, and the first conductive member and the second conductive member have opposite conduction conditions.

By adopting the above technical solution, by setting the first conductive member and the second conductive member with opposite conductive structures, the switching of the low voltage reference circuit and the high voltage reference circuit is realized, ensuring that the low-voltage reference circuit and the high voltage reference circuit cannot be connected to work at the same time.

In an embodiment, the primary control loop includes a control tube and a trigger, a control electrode of the control tube is connected to an output end of the trigger, and the trigger is configured to control the conduction of the control tube.

By adopting the above technical solution, the setting of the control tube and the trigger can control the conduction of the primary control loop to realize the working energy storage of the primary winding.

In an embodiment, an input end of the trigger is connected to a second AND logic device, an input end of the second AND logic device is respectively connected to the control module and the voltage sampler, an output end of the second AND logic device is connected to the trigger, and the second AND logic device is configured to receive a control signal and a judgment signal, and transmit the control signal and judgment signal to the trigger.

By adopting the above technical solution, the second AND logic device can prevent the charging capacitor from not being fully charged, but the control tube is turned on, causing the source of the withstand voltage switch tube to be grounded, so that the charging circuit is disconnected.

In an embodiment, the second logic is connected to the control module and is further configured to obtain a resonance valley signal.

By adopting the above technical solution, the trigger receives the resonance valley signal output by the control module, controls the primary loop to be turned on, and enables the primary coil to work and store energy.

In an embodiment, the primary control loop includes a current detector, the current detector is configured to detect a current size when the primary winding stores energy, and an output end of the current detector is connected to the trigger and configured to output a current detection signal.

By adopting the above technical solution, the current detector can detect the current condition when the primary winding stores energy.

In an embodiment, the output end of the current detector is further connected to the control module and configured to output the current detection signal.

By adopting the above technical solution, it is ensured that the control module can determine whether the primary winding has completed energy storage.

In a second aspect, the present application provides a switching power supply for the switching power supply power replenishment circuit, which adopts the following technical solution.

The switching power supply for the switching power supply power replenishment circuit includes: the primary winding, the secondary winding and the auxiliary winding; the withstand voltage switch tube is connected in series with the primary winding, the charging switch tube and the charging capacitor are connected in series and are arranged in parallel with the primary control loop at one end of the withstand voltage switch tube, and the control module is coupled between the primary control loop and the charging control unit.

In a third aspect, the present application provides a power replenishment method for the switching power supply power replenishment circuit, which adopts the following technical solution.

The power replenishment method for the switching power supply power replenishment circuit includes:
obtaining a resonance valley signal;
obtaining a voltage signal of the charging capacitor, comparing the voltage signal with a low voltage reference value or a high voltage reference value, and outputting a judgment signal; and
determining whether to control the charging switch tube to be turned on based on the resonance valley signal and the judgment signal.

### BRIEF DESCRIPTION OF THE DRAWINGS

FIG. 1 is a schematic diagram of a switching power supply circuit employing a switching power supply power replenishment circuit according to an embodiment of the present application.

FIG. 2 is a partial waveform diagram of a switching power supply power replenishment circuit according to an embodiment of the present application.

FIG. 3 is a power replenishment flow chart of a switching power supply power replenishment method according to an embodiment of the present application.

FIG. 4 is a primary side energy storage flow chart of a switching power supply power replenishment method according to an embodiment of the present application.

### DETAILED DESCRIPTION OF THE EMBODIMENTS

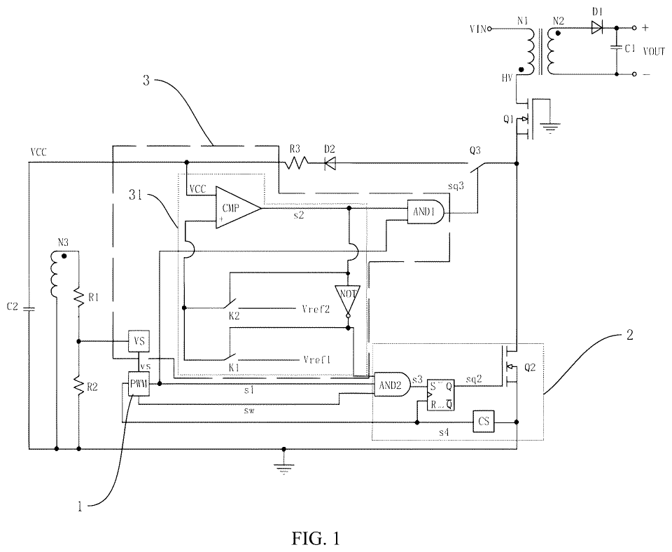

The present application is further described in detail below in conjunction with FIG. 1 to FIG. 4.

Referring to FIG. 1, the present application provides a switching power supply employing a switching power supply power replenishment circuit, and works in a non-continuous mode, including a transformer and a power replenishment circuit. The transformer includes a primary winding N1, a secondary winding N2 and an auxiliary winding N3, and the power replenishment circuit includes: a control module 1, a charging capacitor C2, a withstand voltage switch tube Q1, a charging switch tube Q3, a primary control loop 2 and a charging control unit 3.

The control module 1 is configured to output a control signal for adjusting an output voltage of the switching power supply.

The charging capacitor C2 is configured to store electric energy and provide electric energy for the switching power supply.

The withstand voltage switch tube Q1 is connected between a primary winding N1 and the charging capacitor C2 and configured to obtain a power supply voltage of the primary winding N1 and outputs a charging voltage for charging the charging capacitor C2.

The charging switch tube Q3 is connected between the charging capacitor C2 and the withstand voltage switch tube Q1 and configured to control whether the charging capacitor C2 is charged.

The primary control loop 2 is configured to control whether the primary winding N1 is turned on, when the primary winding N1 is turned on, the primary winding N1 stores energy.

The charging control unit 3 is configured to control whether the charging switch tube Q3 is turned on.

Specifically, the primary winding N1, the withstand voltage switch tube Q1, the charging switch tube Q3 and the charging capacitor C2 constitute a charging circuit, and a third voltage-dividing resistor R3 and a rectifier diode D2 are connected in series between the charging switch tube Q3 and the charging capacitor C2. In an embodiment of the present application, the withstand voltage switch tube Q1 adopts a depletion-type gallium nitride transistor, and utilizes its working characteristics of taking power from the source end. The drain of the withstand voltage switch tube Q1 is connected to the primary winding N1, the gate of the withstand voltage switch tube Q1 is grounded, and the source of the withstand voltage switch tube Q1 is connected to the charging switch tube Q3 and the primary control circuit 2, so it is in a conducting state under normal conditions. When the charging control unit 3 controls the charging switch tube Q3 to turn on, the charging circuit is turned on, and the charging capacitor C2 takes power from the primary winding N1.

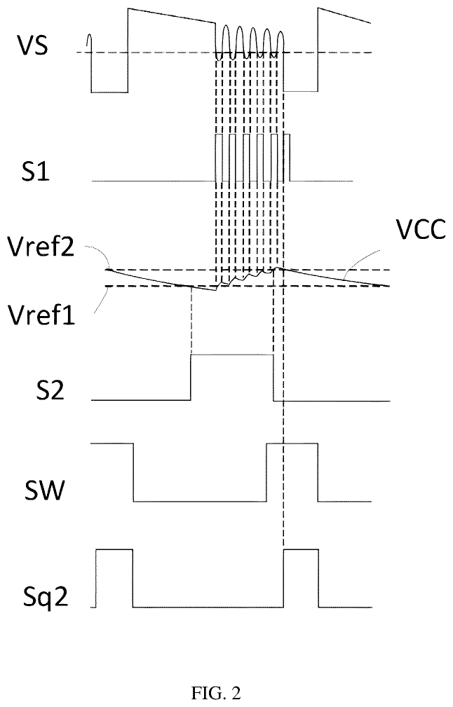

Referring to FIG. 1 and FIG. 2, in order to reduce the charging loss of the withstand voltage switch Q1 when the charging loop is turned on, the charging control unit 3 includes a voltage sampling feedback device VS for detecting the voltage of the auxiliary winding N3, the voltage sampling feedback device VS detects the voltage of the auxiliary winding N3 and outputs a sampling signal vs to the control module 1 when the voltage is at the resonance valley. The first voltage dividing resistor R1 and the second voltage dividing resistor R2 are coupled to both ends of the coil of the auxiliary winding N3. The first voltage dividing resistor R1 and the second voltage dividing resistor R2 are connected in series and are arranged in parallel with the auxiliary winding N3. The input end of the voltage sampling feedback device VS is coupled to one end where the first voltage dividing resistor R1 and the second voltage dividing resistor R2 are connected to obtain the sampling signal vs of the auxiliary winding N3. The output end of the voltage sampling feedback device VS is connected to the control module 1, the control module 1 obtains the sampling signal vs. According to the coupling relationship between the secondary winding N2 and the auxiliary winding N3, the control module 1 can judge whether the secondary winding N2 is fully discharged through the sampling signal vs. One end of the secondary winding N2 is coupled with an output diode D1, and the other end of the output diode D1 is coupled with an output capacitor C1 between the ground, and the two ends of the output capacitor C1 are connected in parallel with a load. When the voltage sampling feedback device VS detects that the auxiliary winding N3 has a resonant voltage, the energy of the secondary winding N2 is completely released. When the voltage sampling feedback device VS detects that the auxiliary winding N3 voltage is at a resonance valley, the voltage sampling feedback device VS outputs a sampling signal vs. The control module 1 receives the sampling signal vs and outputs a resonance valley signal s1. The resonance valley signal s1 is configured to control the charging switch tube Q3 to turn on, so that the charging circuit is turned on when the secondary coil is completely discharged and at the resonance valley. At this time, the source of the withstand voltage switch tube Q1 is in a low voltage state to reduce the charging loss of the withstand voltage switch tube Q1. While the charging circuit is turned on to charge the charging capacitor C2, the primary coil is turned on once to enhance the resonance strength, so that the voltage sampling feedback device VS can detect the resonance valley signal s1.

Referring to FIG. 1 and FIG. 2, in order to prevent the situation that the primary winding N1 still charges the charging capacitor C2 when the charging capacitor C2 has sufficient power and the auxiliary winding N3 is at the bottom of the resonance voltage, the charging control unit 3 also includes a voltage sampler 31, the voltage sampler 31 is preset with a low voltage reference value Vref1, an input end of the voltage sampler 31 is connected to the charging capacitor C2 for obtaining a voltage signal of the charging capacitor C2, and the other input end of the voltage sampler 31 obtains the low voltage reference value Vref1. The voltage sampler 31 compares the voltage signal with the low voltage reference value Vref1 and outputs a judgment signal s2, and the output end of the voltage sampler 31 is coupled to the charging switch tube Q3 and configured to control whether the charging switch tube Q3 is turned on. The output end of the voltage sampler 31 is connected to a first AND logic AND1, the other input end of the first AND logic AND1 is connected to the control module 1 and configured to obtain the resonance bottom signal s1. In an embodiment of the present application, the charging switch tube Q3 is a high-level conduction control, which is not limited to a switch tube such as a triode or a MOS tube; therefore, in an embodiment of the present application, when the voltage sampler 31 and the resonance valley signal s1 are both high-level signal outputs, the first AND logic device AND1 outputs a high-level signal, and the charging switch tube Q3 is turned on.

Referring to FIG. 1 and FIG. 2, in order for the charging capacitor C2 to reserve enough electric energy to meet the energy consumption of the control module 1, the voltage sampler 31 is also preset with a high-voltage reference value Vref2, and the high-voltage reference value Vref2 is greater than the low-voltage reference value Vref1. When the charging capacitor C2 supplies power to the control module 1, its voltage signal is preferentially compared with the low-voltage reference value Vref1. When the voltage signal is less than the low-voltage reference value Vref1, it means that the charging capacitor C2 needs to be recharged. At this time, the voltage sampler 31 compares the high-voltage reference value Vref2 with the voltage signal. When the voltage signal of the charging capacitor C2 does not reach the high-voltage reference value Vref2, the voltage sampler 31 maintains a high-level output. When the voltage signal of the charging capacitor C2 reaches the high voltage reference value Vref2, the voltage sampler 31 compares the voltage value of the charging capacitor C2 with the low voltage reference value Vref1 again.

Referring to FIG. 1, in order to realize the jump between the low voltage reference value Vref1 and the high voltage reference value Vref2, the voltage sampler 31 includes a voltage comparator CMP, a low voltage reference circuit and a high voltage reference circuit arranged at a same direction input end of the voltage comparator CMP, the low voltage reference circuit is configured to provide the low voltage reference value Vref1, and the high voltage reference circuit is configured to provide the high voltage reference value Vref2. In an embodiment of the present application, the low voltage reference circuit and the high voltage reference circuit are connected to the same direction input end of the voltage comparator CMP, and the reverse input end of the comparator is connected to one end of the charging capacitor to obtain the voltage signal. A first conductive member is provided between the output end of the voltage comparator CMP and the low voltage reference circuit, and a second conductive member is provided between the output end of the voltage comparator CMP and the high voltage reference circuit. The conductive structures of the first conductive member and the second conductive member are opposite. In an embodiment of the present application, the first conductive member is demonstrated by taking the first switch K1 and the non-logic device NOT as an example, and the second conductive member is demonstrated by taking the second switch K2 as an example. The first switch K1 and the second switch K2 have the same structure and are both high-level conductive. Similarly, the conductive structures of the first switch K1 and the second switch K2 are opposite. When the conductive structures of the first switch K1 and the second switch K2 are opposite, the non-logic device NOT is not required. In an embodiment of the present application, it is preferred to demonstrate the first switch K1 and the second switch K2 with the same conductive structure as an example to facilitate the design of the primary control loop 2. The first switch K1 controls whether the low voltage reference circuit is connected to the voltage comparator CMP according to the judgment signal s2 processed by the non-logic device NOT, and the second switch K2 controls whether the high voltage reference circuit is connected to the voltage comparator CMP according to the judgment signal s2. Under the action of the non-logic device NOT, the low voltage reference circuit and the high voltage reference circuit cannot be connected to the voltage comparator CMP at the same time.

Referring to FIG. 1, the primary control loop 2 includes a control tube Q2 connected in series between the source and ground of the withstand voltage switch tube Q1 and a trigger RS configured to control whether the control tube Q2 is turned on, and the output end of the trigger RS is connected to the control electrode of the control tube Q2. In an embodiment of the present application, the control tube Q2 is also turned on at a high level, and the control tube Q2 is not limited to switch tubes such as triodes and MOS tubes. The primary winding N1, the withstand voltage switch tube Q1 and the control tube Q2 constitute a primary loop. When the primary loop is turned on, the primary winding N1 stores energy.

Referring to FIG. 1 and FIG. 2, to prevent the situation where the charging capacitor C2 has not completed charging, and the control transistor Q2 is turned on causing the source of the withstand voltage switch tube Q1 to be grounded and thereby interrupting the charging circuit, an input end of the trigger RS is connected to the second AND logic device AND2, and the output end of the second AND logic device AND2 is connected to the trigger RS. An input end of the second AND logic device AND2 is connected to the control module 1, and the other input end of the second AND logic device AND2 is connected to the voltage sampler 31, which is configured to obtain the control signal sw and the judgment signal s2 output by the control module 1, and outputs the trigger signal s3. When the charging capacitor C2 is fully charged and the control signal sw is at a high level, the second AND logic device AND2 can output a high level signal. When the control signal sw is at a high level, the control module 1 adjusts the control according to the load. In an embodiment of the present application, when the voltage signal is greater than the high voltage reference value Vref2, it means that the charging capacitor C2 is fully charged, and at this time the voltage comparator CMP outputs a low level signal. Under the action of the first conductive member, the voltage comparator CMP is connected to the low voltage reference circuit again. Under the action of the second conductive member, the voltage comparator CMP is disconnected from the high voltage reference circuit. When the charging capacitor C2 is fully charged, the control tube Q2 is turned on. This action will extend the dead time, so the input end of the second AND logic device AND2 is connected to the output end of the NOT logic device NOT.

Referring to FIG. 1, in an embodiment of the present application, the trigger is an RS trigger, and the output end of the second AND logic device AND2 is connected to the set end of the trigger RS. According to the trigger characteristics of the RS trigger, when the second AND logic device AND2 outputs a high level signal, the trigger RS outputs a high level signal, at this time, the control tube Q2 is turned on, and the primary winding N1 is turned on to store energy. In order to further reduce the conduction energy consumption of the withstand voltage switch tube, the input end of the second AND logic device AND2 is connected to the control module 1, and is also configured to obtain the resonance valley signal s1, so that the primary loop can also be turned on at the resonance valley, and the primary winding N1 is turned on and starts to store energy in a low voltage state. When the charging capacitor C2 is fully charged, the control signal sw output by the control module 1 is high and the voltage of the auxiliary winding N3 is at the resonance valley, the second AND logic device AND2 outputs a high-level signal, and the trigger RS outputs a high-level signal to turn on the control tube Q2, the primary loop is turned on, and the primary coil stores energy.

Referring to FIG. 1, the primary control loop 2 also includes a current detector CS. The input end of the current detector CS is coupled to the primary loop and configured to obtain the current of the primary loop and output a current sampling signal s4. The output end of the current detector CS is connected to the reset end of the trigger RS. The current detector CS is preset with a current upper limit value. When the primary loop is turned on, the current of the primary loop increases with the increase of the turn-on time. When the primary loop current is greater than the current upper limit value, the current sampling signal s4 output by the current detector CS is a high level. At this time, the reset end of the trigger RS obtains a high level signal. According to the trigger characteristics of the trigger RS, the trigger signal output by the trigger RS jumps from a high level to a low level, the control tube Q2 is cut off, and the primary loop is disconnected. At the same time, the output end of the current detector CS is also connected to the control module 1. The control module 1 determines whether the primary winding has completed energy storage based on the current sampling signal s4. When the control module 1 outputs a high level, the current detector CS samples and detects the current of the primary loop. The control module 1 obtains the current sampling signal s4 output by the current detector CS. When the control module 1 obtains that the current sampling signal s4 is high, it means that the primary winding has completed energy storage. At this time, the control module 1 adjusts the control signal sw, and the control signal sw is converted from a high level to a low level output.

The implementation principle of the embodiment of the present application is: the switching power supply operates in a non-continuous mode, the voltage sampling feedback device VS obtains the voltage of the auxiliary winding N3, and when the auxiliary winding has a resonant voltage and is at the resonance valley, the sampling signal vs is output to the control module 1. The control module 1 learns that the secondary winding N3 has completely released energy through the sampling signal vs, and outputs the resonance valley signal s1.

The voltage comparator CMP obtains the voltage signal of the charging capacitor C2, and compares the voltage signal with the low voltage reference value Vref1. When the voltage signal is less than the low voltage reference value Vref1, it means that the charging capacitor C2 needs to be recharged. At the same time, the connection between the low voltage reference circuit and the voltage comparator CMP is disconnected under the action of the non-logic device, and the voltage comparator CMP is connected to the high voltage reference circuit. The voltage comparator CMP compares the voltage signal with the high voltage reference value, and the judgment signal s2 output by the voltage comparator CMP is a high level signal.

When the voltage comparator CMP outputs a high level signal and the control module 1 outputs the resonance valley signal s1, it means that the charging capacitor needs to be recharged, and the source of the withstand voltage switch tube is in a low voltage state, the charging capacitor may be recharged. At this time, the charging switch tube is turned on, so that the charging circuit is turned on, and the charging capacitor C2 starts to charge. During the charging process, when the voltage signal of the charging capacitor C2 reaches the high voltage reference value Vref2, it means that the charging capacitor is fully charged. Under the action of the non-logic device, the voltage sampler 31 compares the voltage value of the charging capacitor C2 with the low voltage reference value Vref1 again. At this time, the voltage comparator CMP outputs a low level signal, the charging switch tube is cut off, and the charging capacitor stops charging.

After the charging capacitor C2 is fully charged, when the control module 1 outputs the control signal sw as a high level and outputs the resonance valley signal s1, the second AND logic device outputs a high level signal. At this time, the trigger signal s3 output by the trigger RS is a high level, the control tube Q2 is turned on, and the primary winding N1 stores energy. When the charging capacitor C2 does not need to be charged, the control module 1 outputs the control signal sw as a low level. At this time, the energy stored in the primary winding N1 is instantly converted to the secondary winding N2, and the voltage is provided to the load until the current on the secondary coil drops to 0, the secondary winding N3 is turned off, and the resonance voltage begins to appear. At this time, the voltage sampler 31 detects a high voltage, and the voltage comparator CMP outputs a low level signal. When the control module 1 outputs a high level control signal, the voltage sampling feedback device VS detects a resonance voltage valley and outputs the resonance valley signal. The second AND logic device AND2 outputs a high level signal, and the trigger RS outputs a high level signal. At this time, the control tube Q2 is turned on.

When the primary loop is turned on, the current of the primary loop increases with the increase of the conduction time. When the current of the primary loop is greater than the upper limit of the current, the current detector CS outputs a high-level signal. At this time, the reset end of the trigger RS inputs a high-level signal, and the trigger signal output by the trigger RS is converted to a low-level signal, the control tube is cut off and the primary loop is disconnected. While the control module 1 receives the current sampling signal s4 as a high-level signal, the control module 1 adjusts the control signal sw output, and the control signal sw is converted from a high-level signal to a low-level signal.

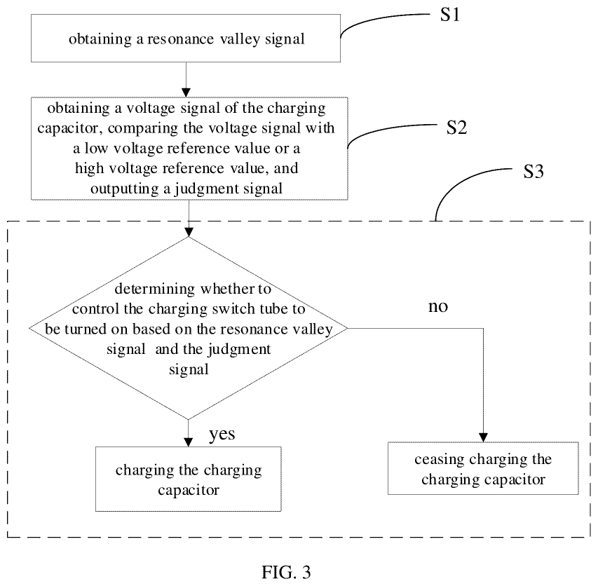

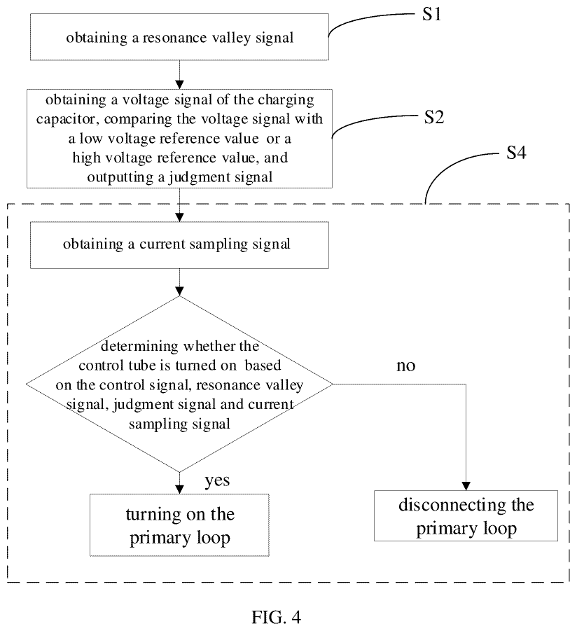

The embodiment of the present application also provides a power replenishment method for a switching power supply power replenishment circuit. Referring to FIG. 3 and FIG. 4, the power replenishment method includes:

S1, obtaining a resonance valley signal s1.

Specifically, the voltage sampling feedback device VS obtains the sampling signal vs, that is, the first voltage-dividing resistor R1 and the second voltage-dividing resistor R2 coupled at both ends of the coil of the auxiliary winding N3. An input end of the voltage sampling feedback device VS is coupled between the first voltage-dividing resistor R1 and the second voltage-dividing resistor R2, so that the voltage sampling feedback device VS collects the sampling signal vs of the auxiliary winding N3 after the voltage is divided by the first voltage-dividing resistor R1 and the second voltage-dividing resistor R2, and outputs the sampling signal vs to the control module 1. The control module 1 determines whether the secondary winding N2 is fully discharged through the sampling signal vs. When the voltage sampling feedback device VS detects a resonant voltage in the auxiliary winding N3, it outputs the sampling signal vs. At this time, the energy of the secondary winding N2 is completely released. The control module 1 obtains the sampling signal vs and outputs the resonance valley signal s1 to the first and logic devices AND1 and the second and logic devices AND2.

S2, obtaining a voltage signal of the charging capacitor C2, comparing the voltage signal with a low voltage reference value Vref1 or a high voltage reference value Vref2, and outputting a judgment signal s2.

Specifically, the voltage sampler 31 obtains the voltage signal and the low voltage reference value Vref1 of the charging capacitor C2, and compares the voltage signal with the low voltage reference value Vref1. If the voltage signal is less than the low voltage reference value Vref1, the charging capacitor C2 needs to be recharged. At this time, under the action of the first conductive member, the voltage comparator CMP is disconnected from the low voltage reference circuit. Under the action of the second conductive member, the voltage comparator CMP is connected to the high voltage reference circuit. At this time, the voltage comparator CMP compares the high voltage reference value Vref2 with the voltage signal. Since the high voltage reference value Vref2 is greater than the low voltage reference value Vref1, the judgment signal s2 output by the voltage sampler 31 is a high level signal. If the voltage signal is greater than the low voltage reference value Vref1, it means that the charging capacitor does not need to be recharged, the judgment signal s2 output by the voltage sampler CMP is a low level signal, and the voltage comparator CMP is still connected to the low voltage reference circuit.

S3, determining whether to control the charging switch tube to be turned on based on the resonance valley signal s1 and the judgment signal s2.

When the voltage sampling feedback device VS detects the resonance voltage bottom of the auxiliary winding N3, the control module 1 receives and outputs the resonance bottom signal s1 as a high level to the first AND logic device AND1. At this time, if the voltage sampler 31 outputs s2 as a high level, that is, the charging capacitor C2 needs to be recharged, then the charging switch tube Q3 is turned on, so that the charging circuit is turned on, and the charging capacitor C2 starts to charge. According to the characteristics of the resonant voltage, when the voltage signal of the charging capacitor C2 does not reach the high-voltage reference value Vref2, and the control module 1 receives the sampling signal vs, that is, when the resonant valley signal s1 output by the control module 1 is high level, the charging switch tube Q2 is turned on, and the charging capacitor C2 starts to charge. When the control module 1 does not receive the sampling signal vs, that is, when the signal output by the control module 1 is low level, the charging switch tube Q3 is cut off, and the charging capacitor C2 stops charging. When the voltage signal of the charging capacitor C2 is greater than the high-voltage reference value Vref2, the voltage sampler 31 outputs a judgment signal s2 as a low level signal, which means that the charging capacitor C2 is fully charged. Under the action of the first conductive member, the voltage sampler 31 re-compares the voltage value of the charging capacitor C2 with the low-voltage reference value Vref1. Since the voltage comparator CMP outputs a judgment signal s2 as a low level, the charging switch tube Q3 is turned off.

S4, obtaining a current sampling signal s4, determining whether the control tube Q2 is turned on based on the control signal sw, the judgment signal s2, the resonance valley signal s1 and the current sampling signal s4; in response to that the control tube Q2 is turned on, turning on the primary loop; or in response to that the control tube Q2 is not turned on, disconnecting the primary loop.

When voltage comparator CMP outputs a low level signal, under the action of non-logic device NOT, the second AND logic device AND2 inputs a high level signal at one end connected to voltage comparator CMP. At this time, if the control signal sw is high level, when the voltage sampling feedback device outputs a resonance valley signal, the second AND logic device AND2 outputs a trigger signal s3 as high level signal. At this time, trigger RS outputs a high level signal, the control tube Q2 is turned on, and the primary winding N1 is turned on to store energy.

As the conduction time of the primary loop increases, the current of the primary loop gradually increases. The current detector is provided with a current upper limit. When the current detector detects that the current of the primary loop is greater than the current upper limit, the current sampling signal s4 output by the current detector CS is high level. At this time, the reset end of the trigger RS receives a high level signal, the trigger RS outputs a low level signal, and the control tube Q2 is cut off, at this time, the primary loop is disconnected. While the control module 1 receives the current sampling signal s4 as a high level, and the control signal sw output by the control module 1 jumps from a high level to a low level. At this time, the energy stored in the primary winding N1 is instantly converted to the secondary winding N2, a voltage is provided to the load until the current on the secondary coil drops to 0, the secondary winding N3 is turned off, and a resonant voltage begins to appear, and the above steps are re-executed.

The embodiment of the present application also discloses a power replenishment chip for a switching power supply. The switching power supply power replenishment circuit disclosed in the above embodiment is integrated in the switching power supply power replenishment chip, including a control module 1, a withstand voltage switch tube Q1, a charging capacitor C2, a charging switch tube Q3, a primary control loop 2 and a charging control unit 3, which can detect a bottom of the resonance voltage by sampling, control the charging switch tube Q3 to turn on to charge the charging capacitor C2 at the bottom of the valley, and control the primary winding N1 to start and store energy at the resonance bottom. The withstand voltage switch tube Q1 and the charging capacitor C2 can not only be integrated in the switching power supply power replenishment chip, but also be independent of the switching power supply power replenishment chip and set separately.

The embodiments of the specific implementation methods of this application are all preferred embodiments of this application, and do not limit the scope of the present application. Therefore, all equivalent changes made based on the structure, shape, and principle of this application should be included in the protection scope of this application.

What is claimed is:

1. A switching power supply power replenishment circuit, applied to a non-continuous mode flyback switching power supply, comprising:
a control module configured to output a control signal for adjusting an output voltage of the switching power supply;
a charging capacitor configured to store electric energy and provide electric energy for the switching power supply;
a withstand voltage switch tube connected between a primary winding and the charging capacitor and configured to obtain a charging voltage for charging the charging capacitor;
a charging switch tube connected between the charging capacitor and the withstand voltage switch tube and configured to control whether the charging capacitor is charged;
a primary control loop configured to control whether the primary winding is turned on, wherein, when the primary winding is turned on, the primary winding stores energy; and
a charging control unit configured to control whether the charging switch tube is turned on;
wherein,
the charging control unit comprises a voltage sampling feedback device configured to detect a voltage signal of an auxiliary winding, and output a sampling signal to the control module when the voltage signal is at a resonance bottom according to the voltage signal;
the control module is configured to receive the sampling signal and output a resonance bottom signal; and
an output end of the control module is coupled to a control electrode of the charging switch tube to enable the charging switch tube to be turned on when it receives the resonance bottom signal.

2. The switching power supply power replenishment circuit according to claim 1, wherein:
the charging control unit further comprises a voltage sampler and a first AND logic device;
the voltage sampler is preset with a high voltage reference value and a low voltage reference value, and the voltage sampler is configured to obtain a voltage signal of the charging capacitor, and compare the voltage signal with the low voltage reference value or the high voltage reference value to output a judgment signal; and
an input end of the first AND logic device is respectively connected to the voltage sampler and the control module, and is configured to obtain a judgment signal and a resonance valley bottom signal, an output end of the first AND logic device is connected to the charging switch tube, and is configured to control the charging switch tube to be turned on or off.

3. The switching power supply power replenishment circuit according to claim 2, wherein:
the voltage sampler comprises a voltage comparator, a low voltage reference circuit and a high voltage reference circuit;
the low voltage reference circuit or the high voltage reference circuit is connected to an input end of the voltage comparator, the low voltage reference circuit is configured to provide a low voltage reference value, the high voltage reference circuit is configured to provide a high voltage reference value;
the other input end of the voltage sampler is connected to the charging capacitor to obtain the voltage signal of the charging capacitor, the voltage sampler compares the voltage signal with the low voltage reference value or the high voltage reference value and outputs the judgment signal; and
an output end of the voltage sampler is connected to the charging switch tube to control whether the charging switch tube is turned on.

4. The switching power supply power replenishment circuit according to claim 3, wherein:
a first conductive member is provided between an output end of the voltage comparator and the low voltage reference circuit, a second conductive member is provided between the output end of the voltage comparator and the high voltage reference circuit; and
the first conductive member is configured to control whether the low voltage reference circuit is connected to the voltage comparator, the second conductive member is configured to control whether the high voltage reference circuit is connected to the voltage comparator, and the first conductive member and the second conductive member have opposite conduction conditions.

5. The switching power supply power replenishment circuit according to claim 2, wherein the primary control loop comprises a control tube and a trigger, a control electrode of the control tube is connected to an output end of the trigger, and the trigger is configured to control the conduction of the control tube.

6. The switching power supply power replenishment circuit according to claim 5, wherein an input end of the trigger is connected to a second AND logic device, an input end of the second AND logic device is respectively connected to the control module and the voltage sampler, an output end of the second AND logic device is connected to the trigger, and the second AND logic device is configured to receive a control signal and a judgment signal, and transmit the control signal and judgment signal to the trigger.

7. The switching power supply power replenishment circuit according to claim 6, wherein the second logic is connected to the control module and is further configured to obtain a resonance valley signal.

8. The switching power supply power replenishment circuit according to claim 5, wherein the primary control loop comprises a current detector, the current detector is configured to detect a current size when the primary winding stores energy, and an output end of the current detector is connected to the trigger and configured to output a current detection signal.

9. The switching power supply power replenishment circuit according to claim 8, wherein the output end of the current detector is further connected to the control module and configured to output the current detection signal.

10. A switching power supply for the switching power supply power replenishment circuit according to claim 1, comprising:
the primary winding, the secondary winding and the auxiliary winding;
wherein the withstand voltage switch tube is connected in series with the primary winding, the charging switch tube and the charging capacitor are connected in series and are arranged in parallel with the primary control loop at one end of the withstand voltage switch tube, and the control module is coupled between the primary control loop and the charging control unit.

11. A power replenishment method for the switching power supply power replenishment circuit according to claim 1, comprising:
obtaining a resonance valley signal;
obtaining a voltage signal of the charging capacitor, comparing the voltage signal with a low voltage reference value or a high voltage reference value, and outputting a judgment signal; and
determining whether to control the charging switch tube to be turned on based on the resonance valley signal and the judgment signal.

12. The power replenishment method according to claim 11, further comprising:
obtaining a current sampling signal, and determining whether the control tube is turned on based on the control signal, the judgment signal, the resonance valley signal and the current sampling signal;
in response to that the control tube is turned on, turning on the primary loop; or
in response to that the control tube is not turned on, disconnecting the primary loop.
